(19) United States
(12) Patent Application Publication
(10) Pub. No.: US 2024/0220365 A1
(43) Pub. Date: Jul. 4, 2024

(54) ERROR AND DEBUG INFORMATION CAPTURING FOR A BOOT PROCESS

(71) Applicant: XILINX, INC., San Jose, CA (US)

(72) Inventors: Ramakrishna Ganeshu POOLLA, Hyderabad (IN); Bharath MULAGONDLA, Hyderabad (IN); Felix BURTON, Foster City, CA (US); Mohan Marutirao DHANAWADE, Hyderabad (IN)

(21) Appl. No.: 18/090,207

(22) Filed: Dec. 28, 2022

(51) Int. Cl. G06F 11/14; G06F 9/4401

(52) U.S. Cl. CPC G06F 11/1417; G06F 9/4401; G06F 2201/805

(57) ABSTRACT

Error and debug information is saved during a boot process. A read only memory (ROM) debug circuitry (RDC) obtains detected errors within ROM code during a boot process. Error information is generated and stored within a first memory element. The error information includes entries. Each of the entries is associated with a respective one of the errors. Debug information is generated and stored by the RDC within a second memory element. The debug information is associated with the boot process. Further, the method includes outputting, via test circuitry of the processing system, the error information and debug information based on a testing instruction.

### TECHNICAL FIELD

Examples of the present disclosure generally relate to capturing error and debug information during a boot process of an integrated circuit device.

### BACKGROUND

An integrated circuit (IC) device may be a system-on-chip (SoC) device, A SoC device includes multiple hardware elements that are initialized during a boot process by a boot image. The boot process is controlled by a processor or processors of the IC device. During the boot process, the integrity of the boot image is checked using authentication and/or encryption methods. In an IC device that includes programmable logic (e.g., an SoC), after power on, system images are copied to memory within the SoC to configure the programmable logic. The system images are bootloaders, operating systems, and/or other software elements.

### SUMMARY

In one example, a method includes executing read only memory (ROM) code by a processing system, and detecting errors within the ROM code during a boot process. Further, the method includes generating, via ROM debug circuitry (RDC) of the processing system, error information and storing the error information within a first memory element, the error information includes entries. Each of the entries is associated with a respective one of the errors. The method further includes generating, via the RDC, debug information and storing the debug information within a second memory element. The debug information is associated with the boot process. Further, the method includes outputting, via test circuitry of the processing system, the error information and debug information based on a testing instruction.

In one example, a RDC obtains errors within ROM code during a boot process. The ROM code is executed by a processing system during the boot process. Further, the RDC generates error information and storing the error information within a first memory element. The error information includes entries. Each of the entries is associated with a respective one of the errors. The RDC generates debug information and stores the debug information within a second memory element. The debug information includes log codes associated with the boot process. The error information and debug information is output from the processing system based on a test instruction.

In one example, a processing system includes one or more controllers that execute ROM code, and detect errors within the ROM code during a boot process. The processing system further includes RCC that generates error information and stores the error information within a first memory element. The error information includes entries. Each of the entries is associated with a respective one of the errors. Further, the RCC generates debug information and stores the debug information within a second memory element. The debug information includes log codes associated with the errors. The error information and debug information are output from the processing system based on a testing instruction.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of an integrated circuit device.

FIG. 2 illustrates a flowchart of a method for generating an error log and debug log.

FIG. 3 illustrates an example error log.

FIG. 4 illustrates an example debug log.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Integrated circuit (IC) devices include various hardware elements that are initialized during a boot process. For example, an IC device may include programmable logic, which is configured based on system images loaded during the boot process. In one example, after power on of an IC device, system images are copied to the memory of the programmable logic. The system images are executed by processors within the programmable logic to configure programmable elements of the programmable logic. The system images are bootloaders, operating systems, and software elements, among others.

In many instances, errors may occur during the boot process. Some errors are fatal and halt the boot process. Other errors do not halt the boot process (e.g., non-fatal errors), The errors that do not halt the boot process are stored and debugged by an administrator and/or a debug system. Current IC devices capture codes associated with two errors that occur during a boot process as first and second entries within a memory. In such instances, during a boot process, the codes associated with a first and last error are captured as the first and second entries within the memory. As errors occur during the boot process, one or more entries within the memory are over-written during the boot process until the boot process is completed. When the boot process is completed the two entries within the memory reflect two errors that occurred during the boot process, e.g., the first error that occurred and the last error that occurred. Accordingly, only two boot errors are available at the completion of a boot process for debugging, and multiple iterations of the boot process are required to debug all of the errors that occur.

In the following, an improved system and method for capturing error information and debug information is described. As is described in greater detail in the following, a processing system of an IC device includes read only memory (ROM) debug circuitry (RDC) that is used to capture error information and debug information within memory elements. As compared to previous boot processes, the RDC captures and records the code for the errors that occur during the boot process as error information entries within a memory element that does not overwrite entries. Further, the RDC captures debug information, which may or may not be associated with the errors. In one or more examples, the debug information contains information related to a successful boot process or information related to a boot process that contains one or more errors. The error information is stored in a memory in which entries are not over-written when the memory is full. For example, when the memory is full, an overflow bit is set. In one example, the error information is stored in a non-circular buffer, such that as errors occur, entries within the error information are not over-written. The use of a non-circular buffer (or another similar memory structure) ensures that as new entries are added to the memory element, entries within the memory element are not overwritten. The debug information is stored as entries within a memory, in which entries may be overwritten. In such a memory, the entries within the memory storing debug information may be output (e.g., printed) during the boot process.

The entries within the error information are accessible by test circuitry of the IC device, and the error information may be used to debug the BootROM, Accordingly, the number of boot iterations used to debug (e.g., correct errors) within the BootROM is reduced, reducing the processing time and resources, reducing the manufacturing cost of the corresponding IC device.

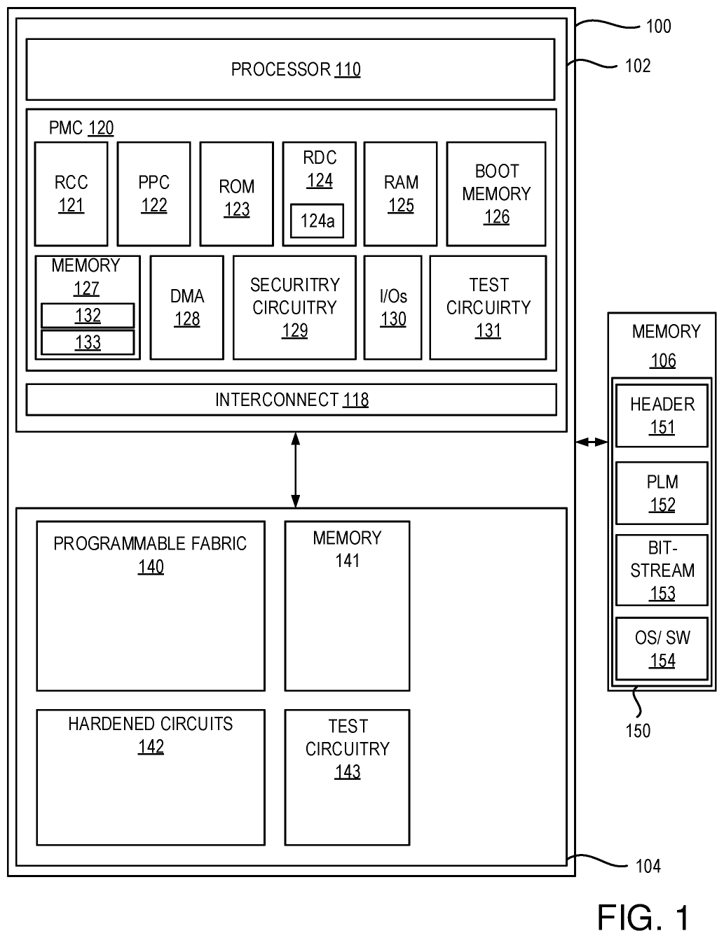

FIG. 1 illustrates an integrated circuit (IC) device 100, according to one or more examples. The IC device 100 includes one or more ICs. In one example, the IC device 100 is a system-on-chip (SoC). Further, the IC device 100 may be a field programmable gate array (FPGA). In one example, the IC device 100 is a field programmable SoC (FPSoC). In one or more examples, the IC device 100 is an application-specific integrated circuit (ASIC) or another type of IC device.

The IC device 100 includes processing system 102 and programmable logic 104. In one or more example, the IC device 100 further includes memory 106. The processing system 102 is connected to the programmable logic 104. Further, the processing system 102 and the programmable logic 104 are connected to the memory 106.

The processing system 102 includes a processor 110, an interconnect 118, and a platform management controller (PMC) 120. In other examples, the processing system 102 may include other elements.

The processor 110 may be a general processing device such as a central processing unit (CPU), among others. In one or more examples, while a single processor 110 is illustrated, the processing system 102 may include multiple processors 110. The processor 110 may include one or more processor units. For example, the processor 110 includes one or more of an application processing unit (APU), and a real-time processing unit (RPU), among others. The processor 110 may include one or more of a memory, interrupt controller, direct memory access (DMA) controllers, memory management units, and floating point unit, among others.

The PMC 120 includes a read only memory (ROM) control circuitry (RCC) 121, platform processing circuitry (PPC) 122, ROM 123, random access memory (RAM) 125, boot memory 126, memory 127, direct memory access (DMA) controller 128, security circuitry 129, inputs/outputs (10s) 130, and test circuitry 131. In other examples, the PMC 120 may include other hardware elements and/or one or more of the above mentioned elements may be omitted from the PMC 120.

The RCC 121 is a processor that executes code of the ROM 123 (e.g., ROM code). The PPC 122 executes bootloader code within the boot memory 126. The ROM 123 stores the ROM code as a boot ROM. In one example, the ROM 123 includes ROM debug circuitry (RDC) 124. In another example, the RDC 124 is external to the ROM 123.

The ROM 123 includes one or more ROM modules that can be distributed to the units of the processor 110. For example, a first processing unit of the processor 110 includes a ROM module of the ROM 123. In one or more examples, the ROM 123 includes a boot ROM code and/or a boot code. The ROM code has access to a key. The key is unchangeable once programmed and stored in hardware. In one example, the key is an advanced encryption standard (AES) key.

The RDC 124 includes a finite state machine (FSM) circuitry 124a that executes the ROM code within the ROM 123. The RDC 124 is described in greater detail in the following. In one or more examples, the FSM circuitry 124a is hardware logic that may be implemented to work independent of the state of the RDC 124. The RDC 124 may use the FSM circuitry 124a to determine, detect, and/or store error information and/or debug information during a boot process. In one or more examples, before ROM code of the ROM 123 is executed, the pre-boot logic (e.g., RCC, and/or PPC, among others) detects errors and triggers the FSM circuitry 124a to store (e.g., log) the detected errors within the memory 127. Further, after the ROM code of the ROM 123 starts executing the FSM circuitry 124a stores (e.g., logs) detected error conditions within the memory 127.

The RAM 125 is used by the RCC 121 as a data memory. Boot memory 126 is a memory for bootloader code that is executed by the PPC 122. The memory 127 is accessible by the RDC 124. In one example, the memory 127 includes memory element 132 and memory element 133. The memory elements 132 and 133 may be buffers. In one example, the memory element 133 is a circular buffer and the memory element 132 is a non-circular buffer. While the memory elements 132 and 133 are illustrated as being included within the memory 127, in other examples, the memory elements 132 and 133 are included in another memory (e.g., the RAM 125, the boot memory 126, the memory 106, or another memory device internal or external to the to the IC device 100) and external to the memory 127. In one or more examples, the memory 127 is a dedicated memory for storing the error information and debug information.

The DMA controller 128 provides hardware elements of the PMC 120 access to the memory 106. The security circuitry 129 is an intellectual property (IP) circuitry that provides authentication and encryption to the processing system 102.

The test circuitry 131 includes a debug access port (DAP) and/or a test access port (TAP) controllers. Further, the test circuitry 131 includes boundary scan chains, internal scan chains, Joint Test Action Group (JTAG) circuits, logic built-in-self-test (LBIST) circuitry, memory BIST (MBIST) circuitry, BISR circuitry, and/or scan-chain clear circuitry, among others.

In one example, the RCC 121 executes the FSM circuitry 124a of the RDC 124 to capture the boot error information. The RCC 121 executes the FSM circuitry 124a of the RDC 124 to capture the debug information. In one or more examples, the RDC 124 stores boot error information within the memory element 132, and debug information within the memory element 133. In one or more examples, the RCC 121 detects errors that occur during the boot phase of the IC device 100. The error information associated with the errors is stored within the memory element 132. The error information includes an error code, additional information, and boot stage information associated with each of the errors. An error code identifies the error that occurred. For example, an error may correspond to a timeout error, a cache parity error, a clock failure error, a BISR error, an initialization error, a memory testing circuitry error, soft reset error, secure boot error, a read error, mode selection error, a mismatch error, a configuration error, an authentication error, data partition error, boot image error, voltage error, authentication error, and a decryption error, among others. Additional information may be error specific. In one or more examples, the additional information is a multi-boot offset that indicates that the boot image offset in the memory that is currently being booted during which the boot error occurred. Further, the additional information corresponds to a driver/structure instance in ROM code that trigger the corresponding error. The additional information may corresponds to value representing the fatality level of the corresponding error, and classification of errors into groups, among others.

Timeout errors correspond to the unavailability of memory resources, testing circuitry resources, and/or other control circuitry resources when requested. A cache parity error corresponds to irregularities within a cache memory. A clock failure error corresponds to a failure in generating and/or receiving a clock signal, or a clock signal with one or more errors. A BISR error corresponds to a failure to initialize and/or can inability to communicate with BISR circuitry. An initialization error corresponds the inability for a memory, control circuitry, and/or test circuitry to be initialized. A memory testing circuitry error corresponds to an error in initializing memory testing circuitry and/or an inability to communicate with the memory testing circuitry. A soft reset error corresponds to an unavailability of a power supply voltage (or voltages) and/or isolations between power supply domains. A secure boot error corresponds an inability to load a BootROM and/or loading an unauthorized BootROM. A read error corresponds to an inability to read from a memory. A mode selection error corresponds to an invalid option being selected and/or incorrect settings of the corresponding communication interface. A mismatch error corresponds to an error initializing a particular boot mode or the initialized boot mode is not set. A configuration error corresponds to an error in locating a boot image file or an error in the configuration of the corresponding interconnect. An authentication error corresponds to an invalid boot mode and/or a boot header authentication error. A partition error corresponds to a data partition length exceeding a limit. A boot image error correspond to an invalid boot image, an invalid key source, or a boot image integrity error. A voltage error corresponds to a voltage glitch (e.g., an erroneous voltage spike or drop). An authentication error corresponds to boot header authentication error, a change in the authentication status, an error occurring when reading an authentication certificate, or a driver authentication error. A decryption error corresponds to a decryption length exceeding an image size or an error in a decryption operation.

The debug information that is logged during the boot process is stored within the memory element 133. In one example, the memory element 133 is a circular buffer. The debug information corresponds to information that may be used during a debugging process. For example, the debug information may identify a function (e.g., a read or write operation or function), an address, and a size. Further, debug values are stored within the memory element 133 as arguments. Debug values may be stored as the arguments within the memory element 133.

In one example, the boot error information and/or debug information is accessible via the test circuitry 131. For example, the boot error information and/or debug information is accessible via a JTAG circuitry (interface) of the test circuitry 131.

The interconnect 118 provides connections between the processing system 102 and the programmable logic 104. Further, the interconnect 118 may provide connections between the processing system 102, the programmable logic 104, and the memory 106.

The programmable logic 104 includes programmable fabric 140, a memory 141, hardened circuits 142, and test circuitry 143. The programmable fabric 140 can be configured to implement various circuits. The programmable fabric 140 includes a large number of different programmable tiles. For example, the programmable fabric 140 includes one or more configurable logic blocks (CLBs), one or more block RAMs (BRAMs), one or more input output blocks (IOBs), and/or one or more digital signal processors (DSPs). A CLB includes configurable logic elements that can be programmed to implement user logic. A BRAM includes memory elements that can be configured to implement different memory structures. An IOB includes IO circuits for transmitting and/or receiving signals to and from the programmable fabric 140. A DSP includes DSP elements that can be configured to implement different digital processing structures. The programmable fabric 140 may further include a programmable interconnect that can be programmed to interconnect various programmable tiles to implement a circuit design. In one or more examples, the programmable fabric 140 is programmed with functionality after manufacture through the loading of a configuration bitstream (e.g., the bitstream 153).

The hardened circuits 142 include various circuits that have dedicated functions. For example, the hardened circuits 142 include transceiver circuitry, interconnect circuitry, and analog-to-digital converter (ADC) circuitry, among others. The hardened circuits are manufactured as part of the IC device 100, and, unlike the programmable fabric, are not programmed with functionality after manufacture through the loading of a configuration bitstream. The hardened circuits 142 are generally considered to have dedicated circuit blocks and interconnects, for example, with particular functionality. The hardened circuits 142 have one or more operation modes that can be set or selected according to parameter settings.

The test circuitry 143 includes boundary scan chains, internal scan chains, TAP controllers, and other JTAG circuitry, among others, for testing the programmable logic 104.

The memory 106 is an NVM. The memory 106 includes a system image 150. In one example, the memory 106 includes more than one system image 150. The system image 150 includes a header 151, a platform loader and management circuitry (PLM) 152, a bitstream 153, and an operating system (OS) or other software (SW) 154.

In one example, during a boot process, the processor 110 executes the ROM 123, which reads the header 151, and reads and authenticates the PLM 152 in the RAM 125. The PLM 152 is executed to load the bitstream 153 into the programmable logic 104 to configure the programmable fabric 140 and begin execution of the OS/SW 154.

In one example, before the ROM 123 is executed, the processing system 102 is initialized (e.g., a power-on initialization). Initializing the processing system 102 includes tasks performed for a power-on reset (e.g., a cold reset) or for a system reset (e.g., a warm reset). In one or more examples, initialization tasks include sequencing of resets to different elements of the processing system 102, monitoring power supplies, initial configuration of clock/reset circuitry, control of the BIST circuitry within the test circuitry 131 and 143, control of redundancy circuitry (BISR circuitry), control of isolation between different parts of the processing system 102 (e.g., power domains, power islands, etc.), and clearing the RAM 125, among others. In one example, the RDC 124 monitors the boot process to detect errors that have occurred.

In one or more examples, a boot process for an IC device (e.g., the IC device 100) includes multiple boot stages. For example, the boot process may include S boot stages, where S is at least one. In one or more examples, S is four or five.

In one example in a first stage of a boot process, the test circuitry 131 and 143 is initialized, the RAM 125 is initialized, and power domains within the IC device 100 are initialized. In one example, during a first stage of the boot process input/output pins of the processing system 102 are monitored to determine whether the pins are asserted or deasserted. In an example where the pins (e.g., I/Os 130) are deasserted, the boot mode is captured from pins. The boot mode is one of a flash boot mode, a NVM boot mode, and a test circuitry boot mode. Further, during the first stage, a determination whether or not to enter a test mode is determined. If the test mode is invoked, any key data in the RAM 125 is cleared. Further, the test circuitry 131 and/or 143 are initialized. If a test mode is not invoked, the scan-chains of the test circuitry 131 and/or 143 are cleared and LBIST circuitry and BISR circuitry of the test circuitry 131 is used to test the logic of one or more of the power domains (e.g., a lower power domain or a high power domain) of the processing system 102.

In a second stage of the boot process, the RCC performs a pre-boot initialization by executing pre-boot initialization code stored in the ROM 123. The pre-boot initialization code specifies a set of initialization tasks that prepare the processing system 102 for execution of the ROM 123. The first and second stages of the boot process correspond to power-on initialization of the IC device 100, and the power-on initialization of the IC device 100 is complete after the completion of the first and second stages of the boot process. In one example, during the second stage, validation of the ROM code is performed to authenticate the ROM code in the ROM 123. If the ROM code is determined to be invalid, the boot process may be halted. Further, during the second stage, the test circuitries 131 and 143 are initialized to perform an LPD and FPD process, and circuit blocks of the PMC 120 are initialized and monitored. The second stage further includes initializing the RAM 125. In one example, one or more modules of the RAM 125 are loaded with zeros to initialize the RAM 125. Further, BISR and/or MBIST operations may be performed on the RAM 125. The power domains of the IC device 100 are initialized during the second stage, which may include the powering down of any disabled power islands.

In a third stage of the boot process, the ROM code within the ROM 123 is executed by one or more units of the processor 110. In the third stage, one or more of the RCC 121 and PPC 122 executes the ROM code within the ROM 123 to read, authenticate, and trigger execution of the PLM 152. In one or more example, the RCC 121 executes the ROM code within the ROM 123 after the PLM 152 is handed off, which is executed by the PPC 122. In the fourth stage, the PLM 152 is executed. The PLM 152 includes tasks for further initialization of the processing system 102 and/or initialization of the programmable logic 104, In one or more examples, the PLM 152 includes task to complete a handoff to the OS/SW 154. In one example during the fourth stage, external power supplies are initiated, and the OS/SW 154 is loaded an executed.

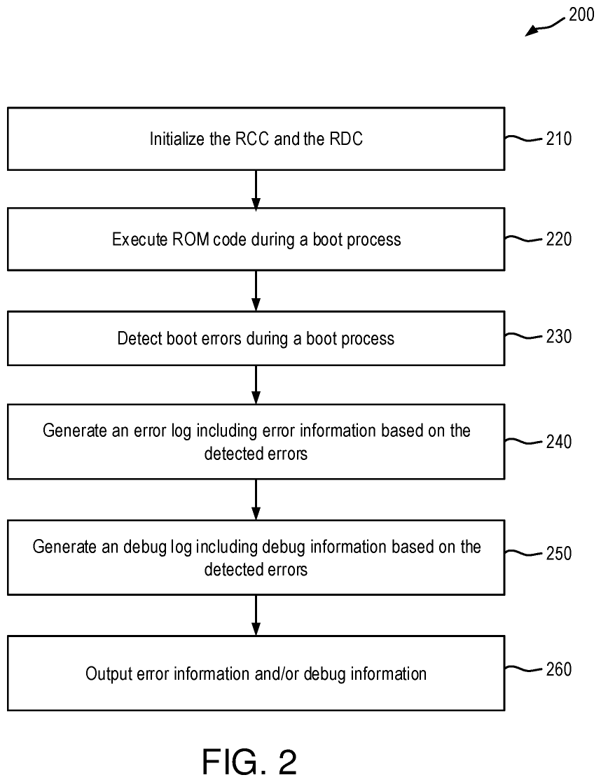

FIG. 2 illustrates a flowchart of a method 200 for determining error information and debug information associated with a boot process, according to one or more examples. The method 200 is performed by the processing system 102. In one example, the method 200 is performed by the RCC 121 and the RDC 124. At 210 of the method 200, an RCC 121 is initialized, initializing the RDC 124. In one example, the RCC 121 is initialized, initializing the FSM circuitry 124a of the RDC 124.

At 220 of the method 200, ROM is executed code during a boot process. The RCC 121 executes the ROM code of the ROM 123. The RCC 121 executes the ROM code of the ROM 123 during a boot process.

At 230 of the method 200, boot errors are detected during the boot process. For example, the ROC 121 boot errors associated with the ROM code of the ROM 123 during the boot process as described above. The RCC 121 monitors the boot process to detect errors that occur.

At 240 of the method 200, an error log including error information is generated based on the detected errors. In one example, the error log includes one or more entries associated with the detected errors. The FSM circuitry 124a of the RDC 124 stores the detected errors within the error log. The ROC 121 executes the FSM circuitry 124a of the RDC 124 to store detected errors within the error log. The FSM circuitry 124a obtains the detect errors from the RCC 121 and stores the errors within an error log within the memory element 132. The error log includes error information for each detected error and is added to the memory element 132. In one example, the memory element 132 is able to store “N” words, where N is one or more. A number of entries within memory element 132 is maintained within a register of the PMC 120. In one example, a register of the PMC 120 indicates that an overflow condition has occurred within the memory element 132. For example, the register indicates that the memory element 132 is full (e.g. an overflow condition has occurred). In one example, when error information associated with an error code is added to the memory element 132, the RDC 124 determines whether or an overflow condition has occurred.

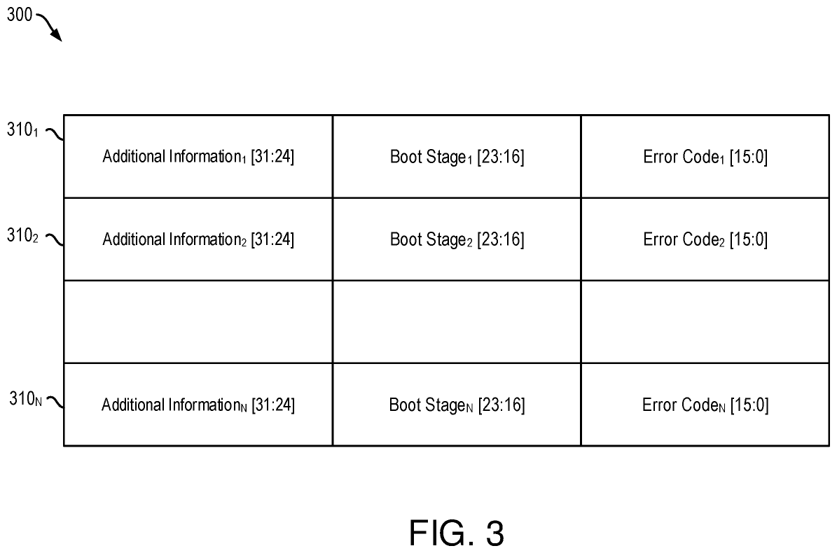

FIG. 3 illustrates example error information 300 stored within the memory element 132. The error information 300 corresponds to an error log. The error information 300 includes entries 310. Each entry 310 corresponds to an error code. For example, the entry 310₁ corresponds to a first error code (Error Code₁), the entry 310₂ corresponds to a second error code (Error Code₂), and the entry 310N corresponds to an Nth error code (Error Codeₙ). Each entry 310 includes a first number of bits associated with the error code, a second number of bits associated boot stage information, and a third number of bits associated with additional information of the corresponding error code. In one example, the number of bits associated with the error code is 16, the number of bits associated with the boot stage is 8, and the number of bits associated with the additional information is 8. In other examples, other number of bits may be used. Each entry 310 may also include a number of reserved bits (e.g., reserved [S:T]. The number of reserved bits is one or more. In one example, the number of reserved bits is four or more. In other examples, other numbers of reserved bits may be used. The reserved bits may be used to store additional information and/or may be used to increase the number of bits used to store the error code, the boot stage, and/or the additional information. In one example, for each error code added to the error information 300, boot stage and additional information are added to a corresponding entry 310.

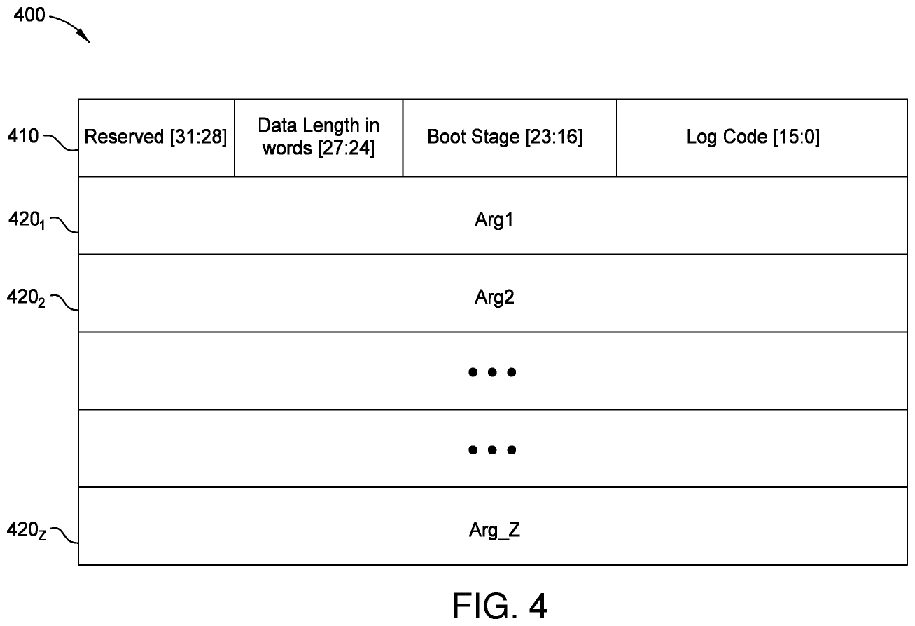

At 250 of the method 200, a debug log including debug information is generated based on boot process. The debug log is generated based on errors. In other examples, the debug log is generated based on a successful boot process. The FSM circuitry 124a of the RDC 124 generates the debug information within the debug log. FIG. 4 illustrates example debug information 400. The debug information 400 is part of a debug log. The debug information 400 includes entries (e.g., debug entries) 410 and associated debug arguments 420. A debug entry includes first bits associated with a log code, second bits associated with a corresponding boot stage, and third bits associated with data length in words. In one example, the number of bits associated with the log code is 16, the number of bits associated with the boot stage is 8, and the number of bits associated with the data length in words is 4. In one example, an entry 410 includes reserved bits. The reserved bits may be used to increase the size (e.g., the number of bits) of the data length, the boot stage, and/or the log code. In one example, the number of reserved bits is 4. In other examples, the number of reserved bits is less than or greater than 4.

The arguments 420 correspond to debug values. The number of arguments 420 corresponds to the value of the data (or payload) length in words within the associated entry 410. In one example, the number of arguments is Z, where Z is one or more. In one example, the ROM code contains the statement printf(“Qspi Flash ID: 0x % x 0x % x 0x % x 0x % x\n\r”, FlashID[0], FlashID[1], FlashID[2], FlashID[3]).” The statement is encoded into a log command where the header contains the log code for the statement, the boot stage in which the debug information occurred, and the length of the payload. In one example, the length of the payload is 4 as there are 4 32-bit values which are logged in the above statement. In one example, the log code for the statement is 0x17 and occurred in the fourth boot stage. Further, the flash ID read during the boot process is 0x2c 0x1b 0x3f and 0xec. Accordingly, the command (cmd) is 0x40417 0x2c 0x1b 0x3f 0xec where CMD HEADER is 0x40417 and payload is 0x2c 0x1b 0x3f 0xec. The first header bits (HEADER[7:0]) 0x17 denote the log code; the second header bits (HEADER[15:8]) 0x4 denote the boot stage; and the third header bits (HEADER [23:16]) 0x4 denote the length of the payload arguments.

In an example where the memory element 133 is a circular memory element, as new entries are added to the memory element 133, one or more entries within the memory element 133 may be overwritten.

At 260 of the method 200, error information and/or debug information is output. For example, the error information and/or the debug information is output via the test circuitry 131 from respective ones of the memory element 132 and 133. In one example, the RDC 124 initiates the test circuitry 131 as part of the boot process. JTAG circuitry of the test circuitry 131 is used to access the error information 300 and/or debug information 400. The error information 300 may be used to determine the errors that have occurred during a boot process, and the corresponding boot stage during which the errors occurred. Further, the additional information may be used to debug the errors that have occurred. Further, the debug information 400 may be used to debug the errors that occurred during the boot process.

In one example, a test instruction (e.g., a JTAG instruction) issued to obtain the debug information 400 from the memory element 133. The test instructions may be instructions used to access the entries within the error log (e.g., the error information 300 of FIG. 3) and/or the debug log (e.g., the debug information 400 of FIG. 4). The payload of the debug information 400 may be encrypted and/or authenticated. In one example, the test circuitry 131 includes debug circuitry that includes a lookup table. The lookup table is used to map a log code within the debug information 400 to a command string. The debug information is stored within the memory element 133 via a command string. In one example, the command string includes a word that contains a constant value that represents the entire string. Additionally, the command string includes words that are the variable arguments (e.g., arguments 420), that are optionally present when the format specifiers are included in the string. For each debug entry that is captured, a binary command is captured.

The command string is output via the test circuitry 131. In one example, the command string includes the log code, and the corresponding boot stage. In one example, for the debug code “SBI Read”, address (boot stage) “0xF0200000”, and size “29920”, a log command (e.g., command of the debug information 400) is “0x00020523 0xF0200000 0x74E0”. In the lookup table, the log command is translated to the command string “SBI Read: Addr:0x % x, Size-% d”. The % x and % d identifiers are replaced with arguments of the log command. The identifiers may be replaced in the order in which the arguments are used to reconstruct the string back as “Stage 5: SBI Read: Addr: 0XF0200000 Size-29920”.

While the foregoing is directed to specific examples, other and further examples may be devised without departing from the basic scope thereof, and the scope thereof is determined by the claims that follow.

What is claimed is:

1. A method comprising:
executing read only memory (ROM) code by a processing system;
detecting errors within the ROM code during a boot process;
generating, via ROM debug circuitry (RDC) of the processing system, error information and storing the error information within a first memory element, wherein the error information includes entries, and each of the entries is associated with a respective one of the errors;
generating, via the RDC, debug information and storing the debug information within a second memory element, wherein the debug information is associated with the boot process; and
outputting, via test circuitry of the processing system, the error information and debug information based on a testing instruction.

2. The method of claim 1, wherein the second memory element is a circular memory element and the first memory element is a non-circular memory element.

3. The method of claim 1, wherein each of the entries includes an error code for the associated error.

4. The method of claim 3, wherein each of the entries further includes additional information and a boot stage for the associated error.

5. The method of claim 1 further comprising indicating an overflow condition of the first memory element based on determining that the first memory element is full.

6. The method of claim 1, wherein the debug information includes debug entries, and each of the debug entries includes a log code, a boot stage, and associated arguments for the debug entry.

7. The method of claim 6, wherein outputting the debug information comprises generating a command string from a log command for a debug entry, the log command including a log code for the debug entry, a boot stage for the debug entry, and arguments for the debug entry.

8. A read only memory (ROM) debug circuitry (RDC) configured to:
obtain errors within ROM code during a boot process, wherein the ROM code is executed by a processing system during the boot process;
generate error information and store the error information within a first memory element, wherein the error information includes entries, and each of the entries is associated with a respective one of the errors; and
generate debug information and store the debug information within a second memory element, wherein the debug information includes log codes associated with the boot process, wherein the error information and debug information are output from the processing system based on a test instruction.

9. The RDC of claim 8, wherein the second memory element is a circular memory element and the first memory element is a non-circular memory element.

10. The RDC of claim 8, wherein each of the entries includes an error code for the associated error.

11. The RDC of claim 10, wherein each of the entries further includes additional information and a boot stage for the associated error.

12. The RDC of claim 8, wherein an overflow condition of the first memory element is indicated based on a determination that the first memory element is full.

13. The RDC of claim 8, wherein the debug information includes debug entries, and each of the debug entries includes a log code, a boot stage, and associated arguments for the debug entry.

14. The RDC of claim 13, wherein outputting the debug information comprises generating a command string from a log command for a debug entry, the log command including a log code for the debug entry, a boot stage for the debug entry, and arguments for the debug entry.

15. A processing system comprising:
one or more controllers configured to:
execute read only memory (ROM) code; and
detect errors within the ROM code during a boot process; and
ROM control circuitry configured to:
generate error information and store the error information within a first memory element, wherein the error information includes entries, and each of the entries associated with a respective one of the errors; and
generate debug information and store the debug information within a second memory element, wherein the debug information includes log codes associated with boot process, wherein the error information and debug information are output from the processing system based on a testing instruction.

16. The processing system of claim 15, wherein the second memory element is a circular memory element and the first memory element is a non-circular memory element.

17. The processing system of claim 15, wherein each of the entries includes an error code for the associated error.

18. The processing system of claim 17, wherein each of the entries further includes additional information and a boot stage for the associated error.

19. The processing system of claim 15, wherein an overflow condition of the first memory element is indicated based on a determination that the first memory element is full.

20. The processing system of claim 15, wherein the debug information includes debug entries, and each of the debug entries includes a log code, a boot stage, and associated arguments for debug entry.
